(19) United States
(12) Patent Application Publication
(10) Pub. No.: US 2015/0199693 A1
(43) Pub. Date: Jul. 16, 2015

(54) System and Method of Monitoring Vehicle Disposal of Regulated Substances

(71) Applicant: David Owen Wehmeyer, Kansas City, MO (US)

(72) Inventor: David Owen Wehmeyer, Kansas City, MO (US)

(21) Appl. No.: 14/593,115

(22) Filed: Jan. 9, 2015

Related U.S. Application Data
(60) Provisional application No. 61/926,456, filed on Jan. 13, 2014.

(51) Int. Cl. G06Q 30/00

(52) U.S. Cl. CPC G06Q 30/018

(57) ABSTRACT

A system and method for monitoring unauthorized disposals of substances by vehicles including processing data indicative of sequences of events, the events preferably including presence in authorized pickup zones, picking up of loads, and presence in authorized disposal zones, and possibly including disposals of loads and amount of load carried or load capacity taken on.

This application is related to and claims priority to provisional patent application Ser. No. 61/926,456 filed Jan. 13, 2014, entitled “System and Method of Monitoring Vehicle Disposal of Regulated Substances” having inventor David Wehmeyer. The contents of said provisional application are herein and hereby incorporated by reference in their entirety.

### FIELD OF THE INVENTION

The field of the invention relates to systems and methods for monitoring unauthorized disposals of loads by vehicles. Vehicles may be referred to herein as trucks, for convenience. Disposals should be understood to include sales.

### BACKGROUND OF THE INVENTION

The instant invention discloses a unique and cost effective process to track and monitor the disposals of loads by one or more vehicles, especially oilfield trucks that may be carrying valuable or regulated substances, such as fracking fluid, saltwater, crude oil, and freshwater. The tracking and monitoring process attempts to insure that authorized substances, picked up at authorized locations, are delivered to authorized disposal or sale locations, thereby keeping the environment safe from illegal dumping of hazardous fluids onto private or public lands, for instance, and/or thereby preventing unauthorized sales.

If there appears to be evidence of unauthorized disposals or sales, in accordance with a tracking and monitoring algorithm, preferably both a responsible party and an enforcing agency would be notified, such as by an e-mail alert or a text message or a phone call alert, whichever they prefer. Preferably then the parties involved can investigate site locations of possible unauthorized disposals or sales and/or review the times, dates, locations and durations of stops at potential disposal or sale sites by a vehicle, depending on data available.

The instant inventive method for determining that a possible unauthorized disposal or sale has taken place is a unique process which, to the inventors' knowledge, has not been practiced in the Automatic Vehicle Location technology field involving the GPS industry. The uniqueness involves integrating GPS type data with truck operation data to effect the result of significantly heightened reliability of alerts.

Basically the novelty of the invention lies in the envisioning, and then testing for proof, that certain truck related operational data could be cost effectively collected and communicated to a processor such that, likely taken together with GPS data and time tagging, the data would significantly generate more accurate and timely alerts. An alert is at least a call to investigate.

In a large part the instant invention has involved creating new vehicle data and, preferably, communicating it to a hub in a vehicle. To the extent possible, relevant data already available would be used. In a preferred embodiment cost effective and relevant data is created and communicated to a vehicle hub.

Sequencing in time of vehicle operation data can be determined by a time tag associated with data, which is relatively easily accomplished with a vehicle hub already receiving GPS data which is time tagged. Basic sequencing in time, however, could also be determined by noting the sequence of receipt of communications at a node.

A preferred embodiment of the inventive methodology preferably works as follows. “Geo-fences” are preferably established by a Data Center around authorized pickup zones of material desired to be monitored and also around approved disposal or sale sites as well. Trucks are equipped with “hubs” or the like which typically collect and communicate GPS data and that can collect and communicate other truck related data and/or messages. (Further data to be taken into consideration could come from other sources such as internal and external databases and memory.) On trucks, sensors are installed to collect contain truck operational data, such as on and off of the Power Take Off (PTO,) and to communicate the data to the truck hub. An alert algorithm system, locatable in whole or in part in truck processor(s) but preferably in Data Center processor(s), takes into account a known or roughly known or calculated or estimated sequential order of events, which preferably includes location data and/or location signals and signals from a truck's PTO (Power Take-Off) unit and/or other relevant truck equipment such as pumps, pickup valves or levers or dump valves or levers. Such signals are communicated to help render more precise and reliable and cost effective the estimation of whether an unauthorized disposal of a substance has likely taken place. Signals indicative of the location of a pickup can indicate that a monitored substance is involved. A simple sequencing of some events is amenable to a simple logic for prediction of a possible unauthorized disposal. As an example, the following truck events could be considered.

A truck enters and/or leaves a location, such as a geo-fenced zone, which is a known pickup point for a monitored substance.

The truck turns on its PTO and/or other equipment, preferably for at least some minimum time, such as a minimum run time of 10 minutes for a PTO. (A minimum PTO run time can likely capture a loading of a truck while a shorter PTO run time might only be a test of the PTO system by a driver of a truck.)

For an approved and/or dismissible sequence, the truck subsequently registers a presence in an authorized disposal zone, preferably also geo-fenced.

If, however, data is received indicative of entering another authorized pick-up zone and/or of picking up another load and/or of disposing of a load, which occurs without data indicative of an intervening presence in an authorized disposal zone, then an “alert” can be generated. (Also, a new sequencing can be begun based on the subsequent presence and/or loading.) Alerts should at least prompt further investigation by interested parties.

Thus, if events are not detected in an approved order, the system can generate an alert for interested parties to investigate a possible unauthorized disposal.

To the inventor's knowledge at the least no AVL tracking system or GPS system is using data indicative of the operation of track equipment or hardware to help predict unauthorized disposals and to trigger alerts. In particular, to the inventor's best knowledge, no AVL tracking system is collecting and using any data other than possibly GPS data, which data could comprise entry data of known locations and exit data and duration of time in-between. Alerts created based on such data above are not significantly reliable. Known current systems have not created and integrated the hardware and software recovery to collect, communicate and utilize relevant data from truck hardware and equipment and/or sensors, such as the operation of the PTO or related valves or levers or pumps, to indicate pickups or dumps. The instant inventors have taken efforts to make such data available to facilitate more reliably predicting unauthorized disposals.

The instant invention discloses preferably using at least PTO data or the like from a truck together with GPS and geo-fencing information or other site presence data to trigger alerts in regard to possible unauthorized disposals. The method relies on a judicious selection of reliable and cost effective truck operational data to create, collect and communicate and relies on the use of at least a simple sequencing algorithm. Testing shows that sequencing of truck information can reliably indicate likely unauthorized disposals. In a simplest form, the method checks that at least a third step follows a first two steps in order to conclude that an authorized disposal takes place, or alternately, that another set of the first two steps (or possibly just a pick up) does not follow the first two steps without an intervening third step. If the system does not detect a proper sequence of events, it can generate an alert for investigation or indicate a need to do so.

Note that the instant invention preferably takes into consideration a possible end of the day scenario where a truck could pick up a legal load and go home for the night and then legally drop-off its load in the morning. The system takes this scenario into consideration because passage of time per se does not necessarily trigger an alert. (Some maximum time interval, such as several days, however could be used to trigger alerts.) The system can permit a driver to enter into an authorized pick up zone without consequences if no load is picked up therein. In a simple preferred embodiment, as long as a truck that has picked up a load in an authorized pickup site does not go into another authorized pick-up area and pick up another load, or possibly just does not pick up another load, or does not dispose of its load, before first going into an authorized disposal area, an alert need not be generated. The algorithm therein may allow a truck to sit for a long amount of time with a legal load onboard, but if the truck enters another predetermined authorized loading area and makes another load pickup or disposes of its load if such can be detected, without first at least going into an authorized disposal area, an alert to investigate may be instigated. Preferably, the interested parties can inquire further about where a monitored load was disposed.

An exception to and improvement on the above simple algorithm may be created if data is available as to the amount of load carried on the truck, or amount carried vis-à-vis the capacity of the truck. In that circumstance a plurality of sequential loads could be permitted up to the truck's load capacity, without an intervening dump or lightening of the load. That is, if the data is available indicative of the percent of load capacity utilized by the truck, for instance, an algorithm of the system might permit sequential entering of authorized pickup zones and picking up of loads. The generation of an alert would be deferred until an indication is received of a decrease in the amount of the load, or of the load capacity, by the truck or otherwise of a dump. Such would indicate a disposal and properly should be preceded by a presence in an approved disposal site.

The amount of time of a run of the PTO at an authorized pick-up zone might give a general idea of how much substance is on board. (Typically, a truck cannot run its PTO without fluid going through or the truck will burn up its pump.) Alternately, other data might indicate the percent of the load capacity of the truck that is being used, including scale data.

An alert gives an interested party the ability to quickly check into an incident to be sure that no violation has occurred. The interested party preferably also will have data and a map showing the entire truck path and any stop duration for that route, day and time. If there have been substances disposed of where the truck shows it stopped for any period of time, soil samples or other data therefrom can verify an unauthorized disposal. Enforcement actions can be implemented based on the evidence received.

Note: trucks are typically pre-identified by their asset number, assigned to it by its owner, and a license plate number, make, model, and VIN number of the truck. Authorized pickup zones and authorized disposal zones are preferably predetermined for algorithms. Alternately, however, an algorithm may be provided with sufficient information in order to estimate or predict whether a vehicle has or had a presence in an authorized pickup zone or an authorized disposal zone.

Maintaining environmental and corporate integrity is crucial in today's oilfields. Monitoring and alerting as quickly as possible that unauthorized disposals or sales have likely taken place, especially of restricted substances, greatly enhances the overall process. Time is of the essence with environmental and conversion crimes. The instant system of detection and protection against these kind of environmental and sales crimes could reduce their occurrence significantly.

Again, to recap, other entities may be currently attempting to provide tracking and monitoring, but to the inventors' best knowledge, they use alert triggers based only upon time and location data. For an example, an entrance into a geo-fenced area and an exit from a geo-fenced area may be noted, and the time duration may be calculated between these two events. These systems lack accuracy, precision and reliability in creating alerts because they do not judiciously incorporate additional data from the operation of the truck hardware and equipment and sensors to calculate an estimate when loads and dumps take place or likely take place. Receiving and analyzing data from the truck PTO and/or fill and dump valves or levers (or additional like equipment) to indicate whether a load or a dump event has likely been preformed, is highly beneficial in order to make the desired calculations for quickly and reliably triggering possible unauthorized disposal alerts. Although tracking processes such as that of the truck PTO likely requires installing additional switches and wiring and may require time to set up sensors in order to achieve the desired results, such is likely cost effective considering the possible damage to the environment or owner.

### SUMMARY OF THE INVENTION

The invention includes methods of monitoring unauthorized disposals of substances by vehicles including receiving data indicative of events. The events most preferably include the presence of a vehicle in an authorized pickup zone; the vehicle taking on of a load; and the presence of the vehicle in an authorized disposal zone. The events can be preferably sequenced. The method includes processing the data with an algorithm to produce or stimulate production of alerts indicative of possible unauthorized disposals. Most preferably, the algorithm includes determining a first set of events for a vehicle including a presence in an authorized pickup zone and a taking on of a load therein. The algorithm then includes determining whether the first set of events are followed by at least a second event, or event set, such as a presence of the vehicle in a pickup zone and/or a taking on of a load. An alert can then be triggered in the absence of an intervening event, such as the presence of the vehicle in an authorized disposal zone, intervening between the first event set above and the second event or set above.

The instant invention also preferably includes a method of monitoring unauthorized disposals of substances by vehicles which includes receiving data indicative of events including the presence of a vehicle in an authorized pickup zone, the vehicle taking on of a load therein and a subsequent load disposal by the vehicle. Preferably, the data is processed with an algorithm to produce an alert indicative of a possible unauthorized load disposal if there has been no intervening event of a presence of the vehicle in an authorized disposal zone, intervening between the first two events above and the third event. The algorithm preferably includes determining a first set of events, including a presence in an authorized pickup zone and a taking on of a load, followed by a second event of a load disposal, wherein if the second event occurs after the first set without an intervening event of presence in an authorized disposal zone, an alert is created or stimulated.

The method could also include receiving data indicative of the amount of load carried by a vehicle, and an algorithm could defer producing alerts until the amount of load carried by the vehicle decreases without an intervening presence in an authorized disposal zone. Such permits a series of partial pickups before an authorized disposal.

Preferably authorized pickup zones and authorized disposal zones are “geo-fenced.” However, data indicative of presence in a zone may include data associated with electronic ticketing technology. Preferably data indicative of a vehicle picking up a load includes data indicative of the vehicle running its PTO for a minimum time, such as at least ten minutes. However, data indicative of a vehicle picking up a load may also include data from an electronic control module for the vehicle. Data indicative of a vehicle picking up a load may include an indication of an operation of a load intake valve. Data indicative of a load disposal may also include data indicative of the operation of a vehicle dump valve. Data indicative of the amount of load carried by the vehicle may include data indicative of an onboard scale reading.

Note that other useful data can also be collected and communicated by systems outside of the truck.

The invention also includes a method of monitoring unauthorized disposals of substances by vehicles comprising receiving at one or more processors data that, at least in combination with other data, is indicative of a presence at an authorized pickup site, a presence at an authorized disposal site and operation of vehicle hardware or equipment associated with picking up of a load or disposing of a load. The latter picking up or disposing operations preferably include at least one of data indicative of operation of the vehicle power take off, the vehicle load intake valve or lever and the vehicle dump valve or lever. The invention includes receiving and/or creating a capacity to sequence at least some of the above data and processing the data in light of the capacity to sequence in order to create or stimulate the creation of alerts of possible unauthorized disposals.

The instant invention also includes a method of monitoring unauthorized disposals of substances by vehicles comprising creating or communicating to a processor vehicle-related data indicative of vehicle events, the vehicle-related data including presence in authorized pickup zone, presence in an authorized disposal zone and at least one from the group of operation of a power take off, operation of a load intake valve or lever, operation of a vehicle load dump valve or lever and operation of truck weighing mechanisms. The method includes sequencing, at least in part, the communicated data and processing to facilitate creating alerts. In the above invention, the processing may be performed at least in part on board the vehicle and/or at least in part in a data center.

### BRIEF DESCRIPTION OF THE DRAWINGS

A better understanding of the present invention can be obtained when the following detailed description of the preferred embodiments are considered in conjunction with the following drawings, in which:

FIG. 1 illustrates in a single drawing a simplified diagram of a preferred embodiment of the instant methodology invention.

The drawings are primarily illustrative. It would be understood that structure may have been simplified and details omitted in order to convey certain aspects of the invention. Scale may be sacrificed to clarity.

### DESCRIPTION OF DETAILED PREFERRED EMBODIMENTS

As a preface, the following list indicates technology that could be useful and helpful to indicate or identify load pickups and/or load drop-offs and/or presence in certain authorized locations by a truck. Using data indicating the running of the PTO on a truck is currently the preferred means, for its simplicity, of indicating a pickup, but many of the below options could be added or substituted as alternative methods, or utilized for more detailed information and more reliable predicting. The invention contemplates using any of the below measuring devices or signals, typically wired to communicate with a vehicle hub, for reporting purposes to enhance the accuracy of the invention.

1) Flow control indication on the intake and dump valves (This would be a switch of some kind that measures fluid flow and amount by having it installed into the intake and outlet of the load and unloading values.)

2) RFID (Radio Frequency Identification technology) (This is technology that uses Radio Frequency Identification (RFID) and transmits data over close proximity to a wireless or landline and could be used to indicate that a particular vehicle or item has come into or out of an area).

3) Onboard Scales Technology (This is hardware added to a truck's suspension that measures weight and could indicate load levels by weight added and removed. The data could be transferred wireless to the cloud.)

4) Electric Ticketing Technology (This is technology that issues an electronic ticket stating the amount of product picked up and delivered to any location. The amount on the ticket can be taken to be the amount involved.)

5) ECM (Electronic Control Module) information for the Vehicle ECM Technology. (This is technology used by the vehicle OEM to measure engine and transmission data to generate fault codes and other important vehicle information. It is a black box installed by the OEM.)

6) Any Blue Tooth Technology reporting weight transfer or fluid flow or electronic ticketing. (Blue tooth technology is a wireless close proximity data transferal to a powered hub device to transmit data collected.)

7) Any information transferred via a SAE J1939, 1708, 1587 or CAN bus to transmit data relating to fluid controls, fluid flow and weight capacities. [CAN bus (for a controller area network) is a vehicle bus standard designed to allow microcontrollers and devices to communicate with each other within a vehicle without a host computer. CAN bus is one of five protocols used in the OBD-II vehicle diagnostics standard. SAE J1939 is the vehicle bus recommended practice used for communication and diagnostics among vehicle components, originally by the car and heavy-duty truck industry in the United States. SAE J1939 is used in the commercial vehicle area for communication throughout the vehicle. With a different physical layer, it is used between the tractor and trailer. This is specified in ISO 11992. SAE J1939 defines five layers in the seven-layer OSI network model, and this includes the Controller Area Network (CAN) 2.0b specification (using only the 29-bit/“extended” identifier) for the physical and data-link layers. Under J1939/11 and J1939/15, the baud rate is specified as 250 kbit/s, with J1939/14 specifying 500 kbit/s. The session and presentation layers are not part of the specification. SAE J1708 is a standard used for serial communications between ECUs on a heavy-duty vehicle and also between a computer and the vehicle. With respect to Open System Interconnection model (OSI), J1708 defines the physical layer. Common higher layer protocols that operate on top of J1708 are SAE J1587 and SAE J1922. The protocol is maintained by SAE International.]

8) Added hardware/software design to measure location, weight, fluid levels, fluid flow control measures, and any other hazardous or non-hazardous materials for delivery and pickup at controlled sites, public or private or governmental in nature. (This covers any other devices that may be added to accomplish the same function as the instant design.)

9) 801.11 WIFI signals used for monitoring systems with a modern attached for data communications or Cellular EV-DO Rev. A modem or hub as well. [IEEE 802.11 is a set of media access control (MAC) and physical layer (PHY) specifications for implementing wireless local area network (WLAN) computer communication in the 2.4, 3.6, 5 and 60 GHz frequency bands. They are created and maintained by the IEEE LAN/MAN Standards Committee (IEEE 802). The base version of the standard was released in 1997 and has had subsequent amendments. The standard and amendments provide the basis for wireless network products using the Wi-Fi brand. While each amendment is officially revoked when it is incorporated in the latest version of the standard, the corporate world tends to market to the revisions because they concisely denote capabilities of their products. As a result, in the market place, each revision tends to become its own standard.]

10) Any device used to measure weight, fluid flow, fluid measurement, type of fluids, or wet or dry materials, in any form of protocols in data for measuring the amount loaded or unloaded, shifting of load, while in transit or parked.

11) NFC technology for near field transfer of data from one device to another for driver ID NFC technology for near field transfer of data from one devise to another for driver ID. EVDO RevA Enhanced Voice-Data Optimized or Enhanced Voice-Data Only (Ev-DO, EV, EVDO, etc.) is a telecommunications standard for the wireless transmission of data through radio signals, typically for broadband Internet access. It uses multiplexing techniques including code division multiple access (CDMA) as well as time division multiplexing (TDM) to maximize both individual users' throughput and the overall system throughput. It is standardized by 3rd Generation Partnership Project 2 (3GPP2) as part of the CDMA2000 family of standards and has been adopted by many mobile phone service providers around the world—particularly those previously employing CDMA networks. It is also used on the Globalstar satellite phone network. EV-DO was designed as an evolution of the CDMA2000 (IS-2000) standard that would support high data rates and could be deployed alongside a wireless carrier's voice services. An EV-DO channel has a bandwidth of 1.25 MHz, the same bandwidth size that IS-95A (IS-95) and IS-2000 (1xRTT) use. The channel structure, on the other hand, is very different. Additionally, the back-end network is entirely packet-based, and thus is not constrained by the restrictions typically present on a circuit switched network. The EV-DO feature of CDMA2000 networks provides access to mobile devices with forward link air interface speeds of up to 2.4 Mbit/s with Rel. 0 and up to 3.1 Mbit/s with Rev. A. The reverse link rate for Rel. 0 can operate up to 153 kbit/s, while Rev. A can operate at up to 1.8 Mbit/s. It was designed to be operated end-to-end as an IP based network, and so it can support any application which can operate on such a network and bit rate constraints.

12) Any voltage signal, blue tooth signal, WIFI signal, EVDO-RevA cellular signal that defines the truck's position, fluid levels, weight, weight dispersion, fluid flows, that come from any source on the truck or trailer, used as data information to indicate loading and unloading of fluids and materials, including dry goods or product of any kind. [Bluetooth is a wireless technology standard for exchanging data over short distances (using short-wavelength radio transmissions in the ISM band from 2400-2480 MHz) from fixed and mobile devices, creating personal area networks (PANs) with high levels of security. Created by telecom vendor Ericsson in 1994, it was originally conceived as a wireless alternative to RS-232 data cables. It can connect several devices, overcoming problems of synchronization.]

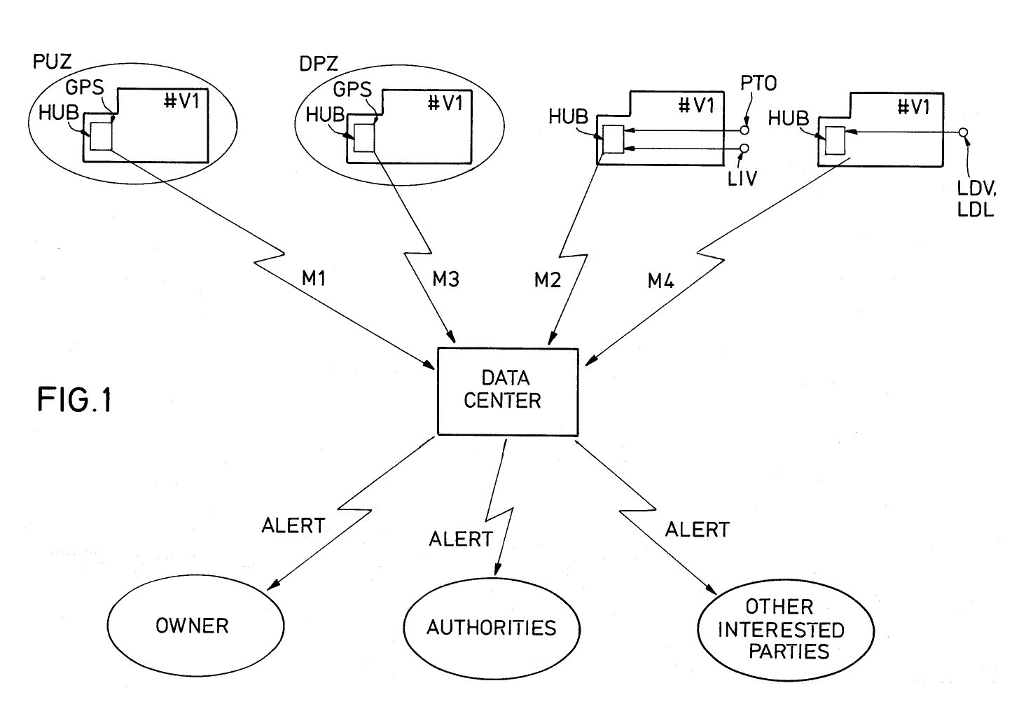

Considering now FIG. 1, FIG. 1 represents one preferred embodiment. However, in theory a Data Center need not exist. Given sufficient computing capacity, which capacity need not be large, each truck or vehicle itself could compute and even transmit its own alerts. For a variety of reasons, at least some of the processing and/or the creating of the alerts are preferably done in a Data Center.

In the simplified embodiment of FIG. 1, four messages are indicated as transmitted from a vehicle hub to a Data Center. Message 1 indicates a presence of a vehicle in an authorized pickup zone PUZ. Preferably, message 1 would include data indicating entering a pickup zone and exiting the pickup zone, preferably each with a time tag, or at least sequenced. The zones themselves could be identified in the data and/or could be identified from stored data together with received data.

Message 3, similarly, indicates a presence of a vehicle in an authorized drop off zone DPZ. Preferably, the data would indicate entrance into the drop off zone and exit from the drop off zone, both with a time tag.

Message 2 indicates data indicative of the operation of some truck or vehicle hardware or equipment or system associated with and indicative of a pickup of a load. In simplest form, this could be an indication of operation of the truck PTO or power take off. Preferably, the turning on of the PTO and the turning off of the PTO would both be able to be discerned and communicated, together with the time of turning on and turning off. Again, all of the data may arrive with its own time tag or may have an inherent sequencing. Alternately, the data may be sequenced, in whole or in part, by the order in which it is presented and/or received at a node. Message 2 could include information in regard to operation of a load input valve LIV or like equipment, typically utilized for picking up a load.

Message 4 indicates operation of load dump equipment, such as load dump valve LDV or a load dump lever LDL. Message 4 includes data indicative of the operation of a disposal or dump. (Both message 3 and message 4 are not necessary to the operation of a successful algorithm.)

FIG. 1 also illustrates a simple algorithm or logic that could be used to indicate an unauthorized disposal. The simple algorithm could proceed as follows. Data indicative of an M1 event and an M2 event during M1 is noted. If the two events are followed by an M3 event, no alert is generated and in fact, the M1, M2 and M3 event data can be deleted or further ignored. However, if data indicative of an M1 event and an M2 event during M1 is followed by further data indicative of an M1 event and/or an M2 event during M1 or of an M4 event without an M3 event, an alert could be created. (If the following further data were an M1 event or an M2 event, or both, that data would be saved for further consideration. If the following further event were a M4 event then the M1, M2 and M4 data could be removed or deleted.)

As discussed earlier, the germ of the invention came from envisioning incorporating some truck or vehicle operational data with GPS data in order to reliably, cost effectively create alerts to investigate probable unauthorized disposals of substances. The substance could be a toxic substance or a regulated substance or any substance of value. An authorized disposal could be a waste disposal or could be a sale for value. Initially envisioned truck operational data comprised data indicating operation of the vehicle power take off mechanism sufficiently to indicate a likely pick up of a load. Testing then showed that a very reliable algorithm could be developed based on just that extra indication of operation of the vehicle. Alternate vehicle operational data can be used with good reliability. Two sets of truck operational data should increase reliability. To the inventor's knowledge, the seriousness of the problem of unauthorized disposals and the capacity to reliably, cost effectively solve the problem was not previously known.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. A method of monitoring unauthorized disposals of substances by vehicles, comprising:
receiving data indicative of events including presence in an authorized pickup zone, taking on a load and presence in an authorized disposal zone; and
processing the data with an algorithm to produce an alert indicative of an unauthorized load disposal wherein the algorithm, in order to avoid producing an alert, include determining that at least a first set of events for a vehicle, including presence in an authorized pickup zone and taking on of a load therein, are followed by a second event for the vehicle, including presence in an authorized disposal zone, before taking on of a subsequent load.

2. A method of monitoring unauthorized disposals of substances by vehicles, comprising:
receiving data indicative of events including presence in an authorized pickup zone, taking on a load, presence in an authorized disposal zone and a load disposal; and
processing the data with an algorithm to produce an alert indicative of an unauthorized load disposal wherein the algorithm, in order to avoid producing an alert, includes determining that a load disposal following a first set of events for a vehicle, wherein the first set of events includes presence in an authorized pickup zone and taking on of a load therein, occurs in an authorized disposal zone.

3. The method of claims 1 or 2 that includes receiving data indicative, directly or indirectly, of the amount of load carried by a vehicle and wherein the algorithm includes deferring producing an alert until the amount of load carried by the vehicle decreases without an intervening event of presence in an authorized disposal zone by the vehicle.

4. The method of claims 1 or 2 wherein the pickup zone and the disposal zone are geo-fenced.

5. The method of claims 1 or 2 wherein the data indicative of the event of a vehicle picking up a load includes at least one of data indicative of the vehicle running its PTO for at least a minimum time, data indicative of an operation of a vehicle load intake valve, data from an electronic control module for the vehicle and data indicating an increase in weight of the vehicle.

6. The method of claim 2 wherein the data indicative of the event of a load disposal includes at least one of data indicative of an operation of a vehicle dump valve and data indicating a decrease in weight of the vehicle.

7. The method of claim 3 wherein the data indicative of the amount of load carried by the vehicle includes data indicative of an onboard scale reading.

8. The method of claims 1 or 2 wherein the data indicative of the event of presence of a vehicle in a zone includes data associated with electronic ticketing technology.

9. A method of monitoring unauthorized disposals of substances by vehicles, comprising:
receiving at one or more processors data that, at least in combination with other data, is indicative of (A) presence in an authorized pickup site; (B) presence in an authorized disposal site; and (C) operation of vehicle hardware or equipment associated with picking up of a load or disposing of a load, the latter picking up or disposing operations including at least one of data indicative of operation of (1) the vehicle power take-off, (2) the vehicle load intake valve; (3) the vehicle dump valve and (4) the vehicle scales;
sequencing at least some of (A), (B) and (C); and
processing (A), (B) and (C) in light of the capacity to sequence and an algorithm in order to create alerts of probable unauthorized disposals.

10. A method of monitoring unauthorized disposals of substances by vehicles, comprising:
communicating to a processor vehicle related data indicative of vehicle events, the vehicle events including: (1) presence in an authorized pickup zone; (2) presence in an authorized disposal zone; and at least one of: (3) operation of a vehicle power take off; (4) operation of a vehicle load intake valve; (5) operation of a vehicle load dump valve and (6) operation of vehicle scales;
sequencing, at least in part, the communicated data in accordance with an algorithm in order to create an alert to investigate a probable unauthorized disposal of a substance by a vehicle.

11. The method of claims 1, 2, or 9 wherein the processing is performed at least in part on board the vehicle.

12. The method of claims 1, 2 or 9 wherein the processing is performed at least in part at a data center.

13. A method of monitoring unauthorized disposals of substances by trucks, comprising:
receiving directly or indirectly 1) truck location event data, including data indicating directly or indirectly presence in an authorized pick-up zone and presence in an authorized disposal zone and/or absence of such presence; and 2) truck operational event data including data indicating directly or indirectly a truck pick-up event or a truck dump event; and
processing the data using an algorithm taking into account, directly or indirectly, a sequencing of events including an event of a presence or absence in an authorized pick-up zone or authorized disposal zone and a pick-up and/or a dump operation for enabling producing an alert to investigate a probable unauthorized disposal of a substance.

14. The method of claim 13 wherein such truck operational event data includes at least one of data indicating operation of a truck power take-off, operation of a truck dump mechanism and change of weight of the truck.
